(19) United States
(12) Patent Application Publication
(10) Pub. No.: US 2023/0224361 A1
(43) Pub. Date: Jul. 13, 2023

(54) SERVICE-AWARE GLOBAL SERVER LOAD BALANCING

(71) Applicant: VMWARE, INC., Palo Alto, CA (US)

(72) Inventors: TAMIL VANAN KARUPPANNAN, Karur (IN); Saurav Suri, Bangalore (IN); Prasanna Kumar Subramanyam, Hyderabad (IN); Venkata Swamy Babu Budumuru, Visakhapatnam (IN); Rakesh Kumar R, Bangalore (IN)

(21) Appl. No.: 17/684,437

(22) Filed: Mar. 2, 2022

(30) Foreign Application Priority Data
Jan. 12, 2022 (IN) 202241001784

(51) Int. Cl. H04L 67/1008; H04L 67/101; H04L 67/1036; H04L 67/561; H04L 67/61

(52) U.S. Cl. CPC H04L 67/1008; H04L 67/101; H04L 67/1036; H04L 67/2804; H04L 67/322

(57) ABSTRACT

Example methods and systems for service-aware global server load balancing are described. One example may involve a first load balancer receiving, from a client device, a request to access a service associated with an application deployed in at least a first cluster and a second cluster. In response to determination that a first pool in the first cluster is associated with an unhealthy status, the first load balancer may identify a second pool implementing the service in the second cluster, the second pool being associated with a healthy status and includes one or more second backend servers selectable by a second load balancer to process the request. Failure handling may be performed by interacting with the client device, or the second load balancer, to allow the client device to access the service implemented by the second pool in the second cluster.

### RELATED APPLICATION

Benefit is claimed under 35 U.S.C. 119(a)-(d) to Foreign Application Serial No. 202241001784 filed in India entitled “SERVICE-AWARE GLOBAL SERVER LOAD BALANCING”, on Jan. 12, 2022, by VMware, Inc., which is herein incorporated in its entirety by reference for all purposes.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtualization computing instances such as virtual machines (VMs) running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc. In practice, an application associated with multiple services may be deployed in a multi-cluster environment. The services are susceptible to failure, which in turn affects application performance and user experience.

### BRIEF DESCRIPTION OF DRAWINGS

FIG. 1 is a schematic diagram illustrating a first example of multi-cluster environment in which service-aware global server load balancing (GSLB) may be performed;

FIG. 2 is a schematic diagram illustrating a physical implementation view of backend servers in an example software-defined networking (SDN) environment;

FIG. 3 is a flowchart of an example process for a first load balancer to perform service-aware GSLB;

FIG. 4 is a flowchart of an example detailed process for a first load balancer to perform service-aware GSLB according to a proxy-based approach;

FIG. 5A is a schematic diagram illustrating an example GSLB service configuration according to a proxy-based approach;

FIG. 5B is a schematic diagram illustrating an example failure handling configuration for a first load balancer according to a proxy-based approach;

FIG. 5C is a schematic diagram illustrating an example failure handling configuration for a second load balancer according to a proxy-based approach;

FIG. 6 is a schematic diagram illustrating an example of service-aware GSLB according to a proxy-based approach;

FIG. 7 is a flowchart of an example detailed process for a first load balancer to perform service-aware GSLB according to a redirect-based approach;

FIG. 8A is a schematic diagram illustrating an example GSLB service configuration according to a redirect-based approach;

FIG. 8B is a schematic diagram illustrating an example failure handling configuration for a first load balancer according to a redirect-based approach;

FIG. 8C is a schematic diagram illustrating an example failure handling configuration for a second load balancer according to a redirect-based approach; and

FIG. 9 is a schematic diagram illustrating an example of service-aware GSLB according to a redirect-based approach.

### DETAILED DESCRIPTION

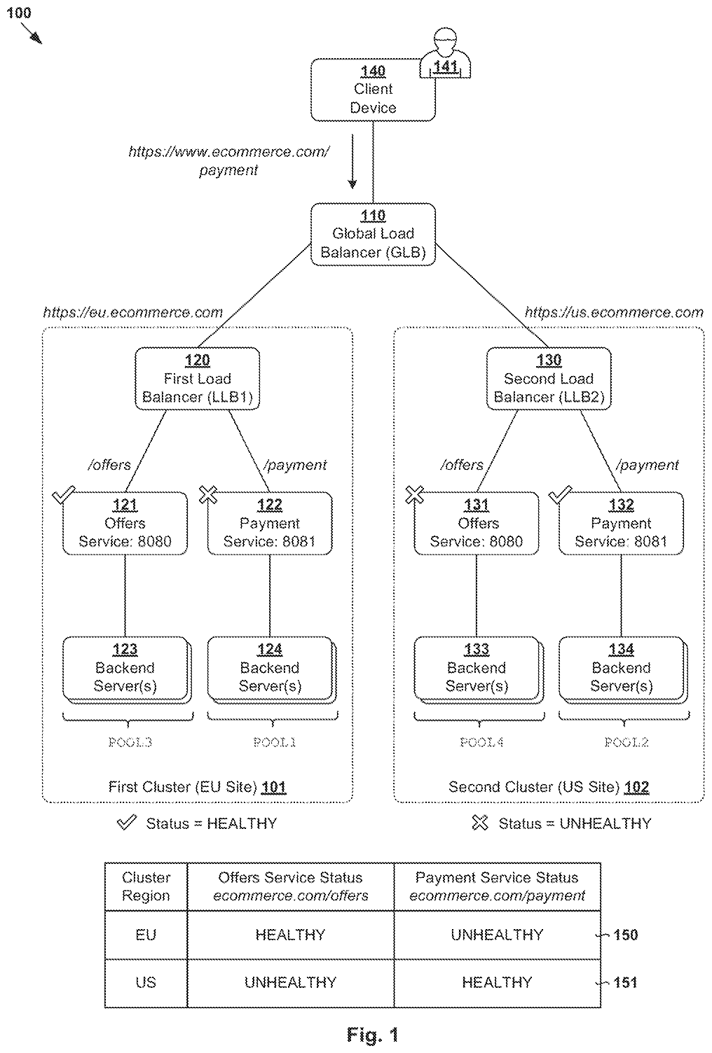

According to examples of the present disclosure, service-aware global server load balancing (GSLB) may be implemented to facilitate high availability and disaster recovery. One example may involve a first load balancer (e.g., LLB1 120 in FIG. 1) receiving, from a client device, a request to access a service associated with an application that is deployed in at least a first cluster and a second cluster (e.g., 101-102 in FIG. 1). The request may be directed towards the first load balancer based on load balancing by a global load balancer (e.g., GLB 110 in FIG. 1). The first load balancer may then identify a first pool implementing the service in the first cluster (e.g., payment service 122 in FIG. 1). The first pool may include first backend server(s) selectable by the first load balancer to process the request.

In response to determination that the first pool in the first cluster is associated with an unhealthy status, the first load balancer may identify a second pool implementing the service in the second cluster (e.g., payment service 132 in FIG. 1). The second pool may be associated with a healthy status and include second backend server(s) selectable by a second load balancer (e.g., LLB2 130 in FIG. 1) to process the request. Failure handling may be performed by interacting with the client device, or the second load balancer, to allow the client device to access the service implemented by the second pool in the second cluster. Using examples of the present disclosure, failure handling may be performed in a more proactive manner to reduce service downtime, improve application performance and enhance user experience.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

FIG. 1 is a schematic diagram illustrating a first example of multi-cluster environment 100 in which service-aware global server load balancing (GSLB) may be performed. It should be understood that, depending on the desired implementation, environment 100 may include additional and/or alternative components than that shown in FIG. 1. In practice, environment 100 may include any number of hosts (also known as “computer systems,” “computing devices”, “host computers”, “host devices”, “physical servers”, “server systems”, “transport nodes,” etc.).

In general, GSLB may refer to a technology for distributing an application's load or traffic across multiple geographically-dispersed sites or clusters. For example in FIG. 1, an application may be deployed in multi-cluster environment 100 that includes a first GSLB cluster (see 101) located at a first site in the European (EU) region and a second GSLB cluster (see 102) at a second site in the United States (US) region. The application may be accessible by user 141 operating client device 140 via a website (e.g., www.ecommerce.com) that is hosted across first cluster 101 and second cluster 102. Depending on the desired implementation, cluster 101/102 may represent a data center or cloud (private or public) in which the application is deployed.

In practice, multi-cluster application deployment has become a paradigm for high availability and disaster recovery scenarios. Any suitable technology for application deployment may be used. For example, as the adoption of application architectures based on micro-services gains momentum, Kubernetes® is becoming a de facto orchestration engine to facilitate their deployments. In this case, the application may be deployed across Kubernetes clusters (e.g., 101-102) and use ingress objects to expose micro-services associated with the application to users. Further, GSLB based on using domain name system (DNS) may be implemented to steer traffic across multiple clusters intelligently and distribute client requests across Kubernetes® ingress objects in different clusters 101-102.

In the example in FIG. 1, traffic steering may be implemented using multiple load balancers, including a global load balancer (see “GLB” 110), a first local load balancer (see “LLB1” 120) in first cluster 101 and a second local load balancer (see “LLB2” 130) in second cluster 102. When a client device 140 operated by user 141 performs a DNS query on a fully qualified domain name (FQDN), GLB 110 may perform load balancing by responding with a virtual Internet Protocol (IP) address associated with a selected cluster. The selection may depend on any suitable load balancing algorithm, such as based on health or load information associated with cluster 101/102, proximity based on location information associated with client device 140, etc.

Using a micro-service architecture, the application may be associated with multiple virtual services running in clusters 101-102, such as “offers” service (see 121/132) and “payment” service (see 122/132). The offers service may be associated with URL=“www.ecommerce.com/offers” (see 121/131) and payment service associated with URL=“www.ecommerce.com/payment.” These services may be implemented by backend servers (see 123-124, 133-134). In this case, LLB 120/130 may act as an ingress object that is associated with multiple services in cluster 101/102.

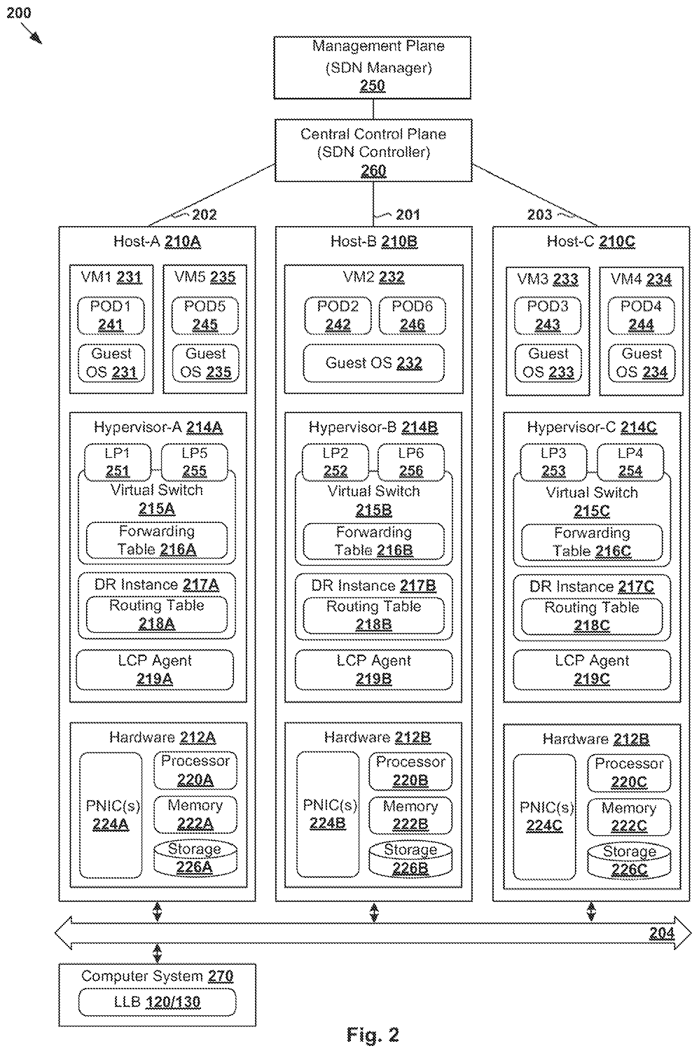

Throughout the present disclosure, the term “backend server” may refer generally to a physical machine (bare metal machine), or a virtualized computing instance, such as a Kubernetes pod, etc. In general, a pod is the smallest execution unit in Kubernetes, such as a virtual machine (VM) with a small footprint that runs one or more containers. Some example pods (see 241-246) running in respective isolated VMs (see 231-235) will be discussed using FIG. 2.

Physical Implementation View

FIG. 2 is a schematic diagram illustrating a physical implementation view of backend servers in example software-defined networking (SDN) environment 200. Depending on the desired implementation, SDN environment 200 may include additional and/or alternative components than that shown in FIG. 2. For example, SDN environment 200 may include multiple physical hosts, such as host-A 210A, host-B 210B and host-C 210C that are inter-connected via physical network 204. Note that SDN environment 200 may include any number of hosts (also known as a “host computers”, “host devices”, “physical servers”, “server systems”, “transport nodes,” etc.), where each host may be supporting tens or hundreds of VMs.

Each host 210A/210B/210C may include suitable hardware 212A/212B/212C and virtualization software (e.g., hypervisor-A 214A, hypervisor-B 214B, hypervisor-C 214C) to support various VMs 231-235. For example, host-A 210A supports VM1 231 and VM5 235; host-B 210B supports VM2 232; and host-C 210C supports VM3 233 and VM4 234. Hypervisor 214A/214B/214C maintains a mapping between underlying hardware 212A/212B/212C and virtual resources allocated to respective VMs 231-235. Hardware 212A/212B/212C includes suitable physical components, such as central processing unit (CPU) or processor 220A/220B/220C; memory 222A/222B/222C; physical network interface controllers (NICs) 224A/224B/224C; and storage disk(s) 226A/226B/226C, etc.

Virtual resources are allocated to VMs 231-235 to support respective guest operating systems (OS) 231-235 and application(s). For example, container(s) in POD1 241 may run inside VM1 231, POD2 242 and POD6 246 inside VM2 232, POD3 242 inside VM3 233, POD4 inside VM4 244 and PODS inside VM5 235. The virtual resources (not shown for simplicity) may include virtual CPU, guest physical memory, virtual disk, virtual network interface controller (VNIC), etc. In practice, one VM may be associated with multiple VNICs and hardware resources may be emulated using virtual machine monitors (VMMs). VMs 231-235 may interact with any suitable computer system 270 supporting a load balancer (e.g., LLB1 120 or LLB2 130 in FIG. 1) to implement an application with micro-service architecture.

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 214A-C may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” may refer generally to multiple packets. The term “layer-2” may refer generally to a link layer or Media Access Control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Although not shown in FIG. 2, each POD may run one or more containers having shared network and storage resources. As used herein, the term “container” (also known as “container instance”) is used generally to describe an application that is encapsulated with all its dependencies (e.g., binaries, libraries, etc.). Containers are “OS-less”, meaning that they do not include any OS that could weigh 10s of Gigabytes (GB). This makes containers more lightweight, portable, efficient and suitable for delivery into an isolated OS environment. In practice, running containers inside a virtual machine (VM) or node not only leverages the benefits of container technologies but also that of virtualization technologies.

Hosts 210A-C maintains data-plane connectivity with each other via physical network 204 to facilitate communication among VMs located on the same logical overlay network. Hypervisor 214A/214B/214C may implement a virtual tunnel endpoint (VTEP) to encapsulate and decapsulate packets with an outer header (also known as a tunnel header) identifying the relevant logical overlay network. For example, hypervisor-A 214A implements a first VTEP associated with (IP address=IP-A, MAC address=MAC-A). Hypervisor-B 214B implements a second VTEP with (IP-B, MAC-B), and hypervisor-C 214C a third VTEP with (IP-C, MAC-C). Encapsulated packets may be sent via a tunnel established between a pair of VTEPs over physical network 204, over which respective hosts are in layer-3 connectivity with one another.

Each host 210A/210B/210C may implement local control plane (LCP) agent 219A/219B/219C to interact with management entities, such as SDN manager 250 residing on a management plane and SDN controller 260 on a central control plane. For example, control-plane channel 201/202/203 may be established between SDN controller 260 and host 210A/210B/210C using TCP over Secure Sockets Layer (SSL), etc. Management entity 250/260 may be implemented using physical machine(s), virtual machine(s), a combination thereof, etc. One example of a SDN controller is the NSX controller component of VMware NSX® (available from VMware, Inc.), which is configurable using SDN manager 250 in the form of an NSX manager.

Hypervisor 214A/214B/214C implements virtual switch 215A/215B/215C and logical distributed router (DR) instance 217A/217B/217C to handle egress packets from, and ingress packets to, corresponding VMs 231-235. In SDN environment 200, logical switches and logical DRs may be implemented in a distributed manner and can span multiple hosts to connect VMs 231-235. For example, logical switches that provide logical layer-2 connectivity may be implemented collectively by virtual switches 215A-C and represented internally using forwarding tables 216A-C at respective virtual switches 215A-C. Forwarding tables 216A-C may each include entries that collectively implement the respective logical switches. Further, logical DRs that provide logical layer-3 connectivity may be implemented collectively by DR instances 217A-C and represented internally using routing tables 218A-C at respective DR instances 217A-C. Routing tables 218A-C may each include entries that collectively implement the respective logical DRs.

Packets may be received from, or sent to, a VM or a pod running inside the VM via a logical switch port, such as LP1 to LP6 251-256. Here, the term “logical port” or “logical switch port” may refer generally to a port on a logical switch to which a virtualized computing instance is connected. A “logical switch” may refer generally to an SDN construct that is collectively implemented by virtual switches 215A-C in the example in FIG. 1, whereas a “virtual switch” may refer generally to a software switch or software implementation of a physical switch. In practice, there is usually a one-to-one mapping between a logical port on a logical switch and a virtual port on virtual switch 215A/215B/215C. However, the mapping may change in some scenarios, such as when the logical port is mapped to a different virtual port on a different virtual switch after migration of the corresponding VM (e.g., when the source host and destination host do not have a distributed virtual switch spanning them).

Through virtualization of networking services in SDN environment 200, logical overlay networks may be provisioned, changed, stored, deleted and restored programmatically without having to reconfigure the underlying physical hardware architecture. A logical overlay network (also known as “logical network”) may be formed using any suitable tunneling protocol, such as Virtual eXtensible Local Area Network (VXLAN), Stateless Transport Tunneling (STT), Generic Network Virtualization Encapsulation (GENEVE), etc.

Service-Aware GSLB

Conventionally, failure handling in multi-cluster environment 100 in FIG. 1 may be inadequate. For example in FIG. 1, consider a scenario in first cluster 101 in the EU region where payment service 122 is associated with status=UNHEALTHY (i.e., DOWN), while offers service 121 is HEALTHY (see 150). In second cluster 102 in the US region, however, payment service 132 is HEALTHTY (i.e., UP), while offers service 131 is UNHEALTHTY (see 151). Conventionally, there is a requirement where the minimum number of services up and running equals to the number of services (e.g., min_hm_up=2) in each cluster 101/102. In this case, since only one service is HEALTHY in each cluster 101/102, the application may be considered to be down in both clusters 101-102. This causes GLB 110 to avoid steering traffic to both LLB1 120 and LLB2 130, rendering the application to be inaccessible.

According to examples of the present disclosure, a service-aware approach for GSLB may be implemented to facilitate high availability and disaster recovery in multi-cluster environment 100. The service-aware approach may be implemented to provide more visibility or insight into the health status information of individual services in each cluster 101/102. For example in FIG. 1, when a particular service (e.g., payment 122/132) is associated with status=UNHEALTHTY in first cluster 101 but HEALTHY in second cluster 102, failure handling may be performed by proxying or redirecting a client's request for that service from LLB1 120 to LLB2 130.

Using examples of the present disclosure, failure handling may be performed in a more proactive manner based on the health status information to reduce service downtime, improve application performance, and enhance user experience. This should be contrasted against the conventional approach of avoiding traffic to entire cluster 101/102 when one of its services is associated with status=UNHEALTHY. Throughout the present disclosure, GLB 110 will be used as an example “global load balancer,” LLB1 120 supported by a first computer system as an example “first load balancer” in first cluster 101, LLB2 130 supported by a second computer system as an example “second load balancer” in second cluster 102. An example service is payment service 122/132 implemented by a first pool of backend server(s) 124 in first cluster 101, and a second pool of backend server(s) 134 in second cluster 102.

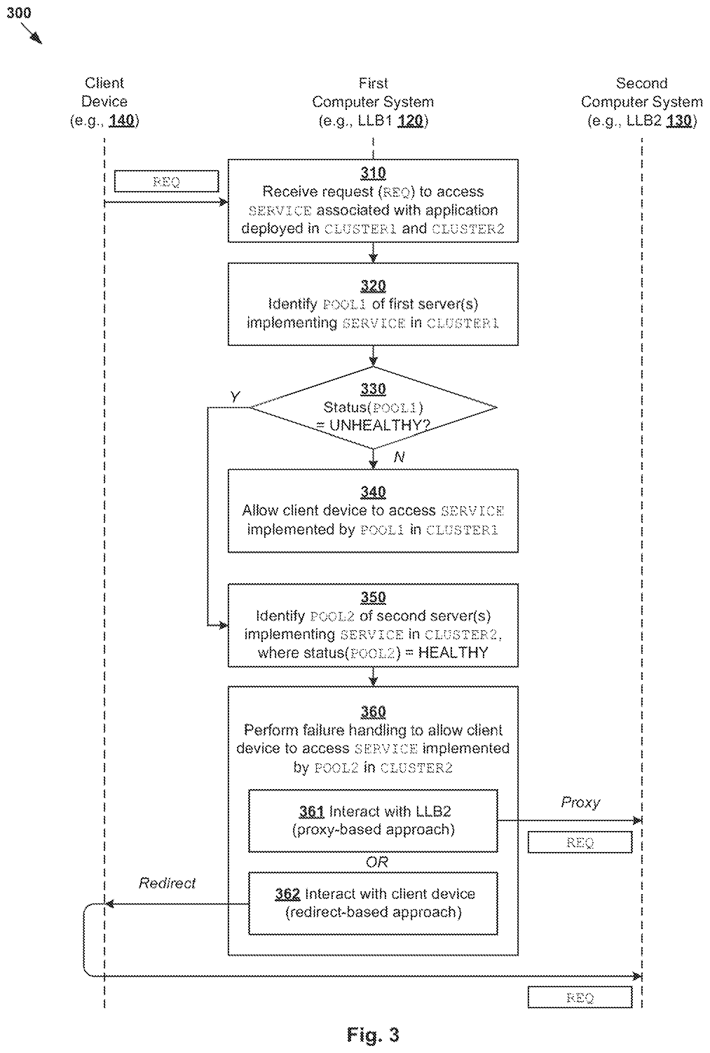

Some examples will be described using FIG. 3, which is a flowchart of example process 300 for a first load balancer to perform service-aware GSLB. Example process 300 may include one or more operations, functions, or actions illustrated by one or more blocks, such as 310 to 360. Depending on the desired implementation, various blocks may be combined into fewer blocks, divided into additional blocks, and/or eliminated. Any suitable computer system (see 270 in FIG. 2) may be configured to implement load balancer 120/130, such as a physical machine (bare metal), virtual machine deployed in SDN environment 200, etc.

At 310 in FIG. 3, LLB1 120 may receive a request to access a service associated with an application from client device 140 operated by user 141. As described using the example in FIG. 1, the application may be associated with multiple services and deployed in at least first cluster 101 and second cluster 102. The request may be directed towards first load balancer 120 based on load balancing by GLB 110 using any suitable algorithm.

At 320 in FIG. 3, LLB1 120 may identify a first pool implementing the service in first cluster 101 based on the request. The first pool may include first backend server(s) 124 selectable by the LLB1 120 to process the request. At 330 (no) and 340, in response to determination that the first pool in first cluster 101 is associated with status=HEALTHY, LLB1 120 may allow client device 140 to access the service implemented by the first pool in first cluster 101.

Otherwise, at 330 (yes) and 350 in FIG. 3, in response to determination that the first pool in first cluster 101 is associated with status=UNHEALTHY, LLB1 120 may identify a second pool implementing the service in second cluster 102. The second pool is associated with a healthy status and includes second backend server(s) 134 selectable by a LLB2 130 to process the request. Depending on the desired implementation, LLB1 120 may identify the unhealthy status associated with the first pool and the healthy status associated with the second pool based on information obtained from health monitor(s).

At 360 in FIG. 3, LLB1 120 may perform failure handling by interacting with client device 140, or LLB2 130, to allow client device 140 to access the service implemented by the second pool in second cluster 102. Note that even when service=offers (see 131) is associated with status=UNHEALTHY in second cluster 102, service=payment (see 132) is associated with status=HEALTHY (i.e., up and running). In this case, the second pool of second backend server(s) 134 may continue to process client's requests for service=payment. Depending on the desired implementation, block 360 may involve LLB1 120 proxying or redirecting the request towards LLB2 130 based on a configuration performed prior to receiving the request.

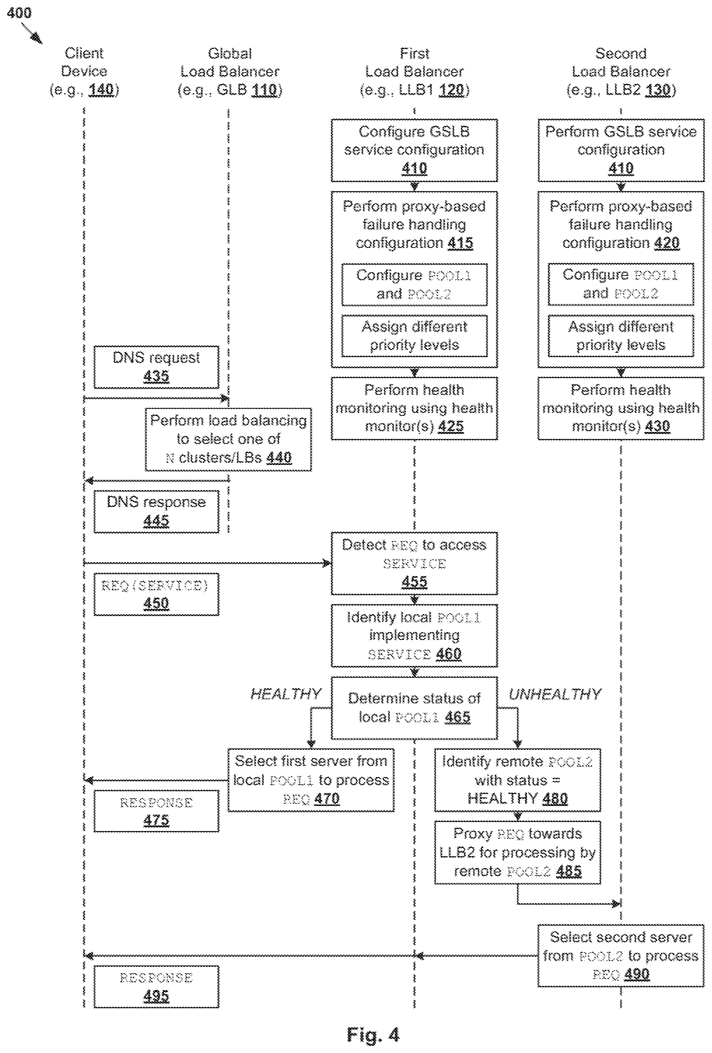

According to a proxy-based approach (see 361 in FIG. 3), LLB1 120 may proxy the request towards (i.e., interact with) LLB2 130 to cause LLB2 130 to select a particular second backend server to process the request. In this case, prior to receiving the request, LLB1 120 may perform failure handling configuration that includes (a) configuring a pool group that includes the first pool and the second pool implementing the service and (b) assigning the second pool with a second priority level that is lower than a first priority level assigned to the first pool. Compared to the redirect-based approach, the proxy-based approach may be implemented in a manner that is transparent to user 141. However, the proxy-based approach may cause more resource usage at LLB1 120 and cross-cluster traffic. Various examples will be discussed using FIGS. 4-6.

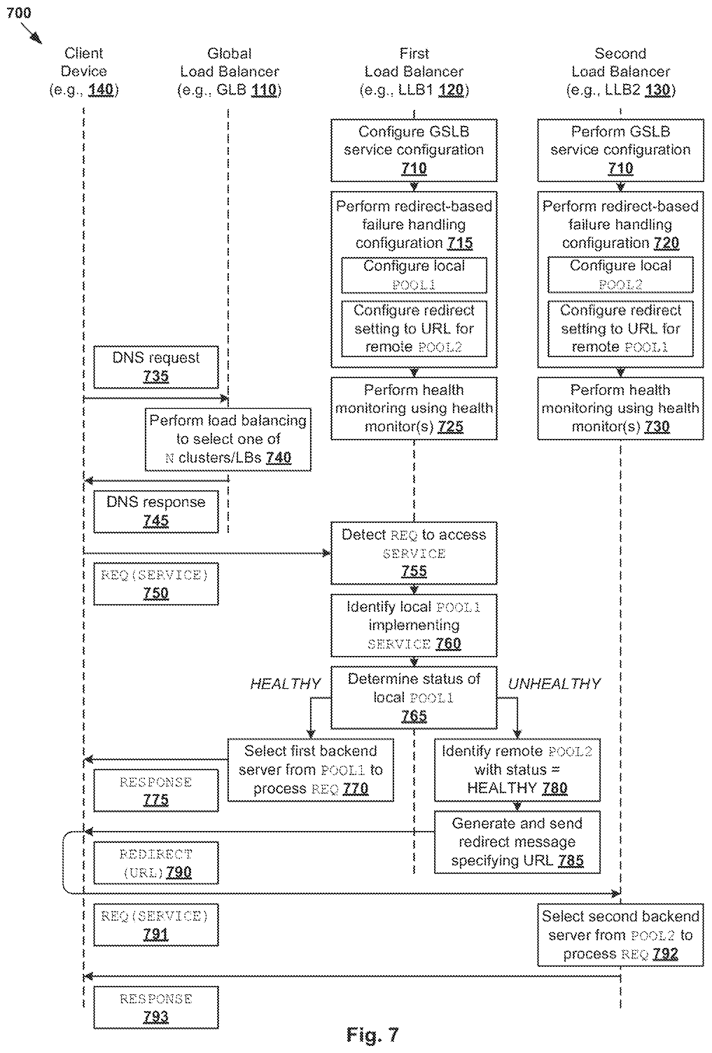

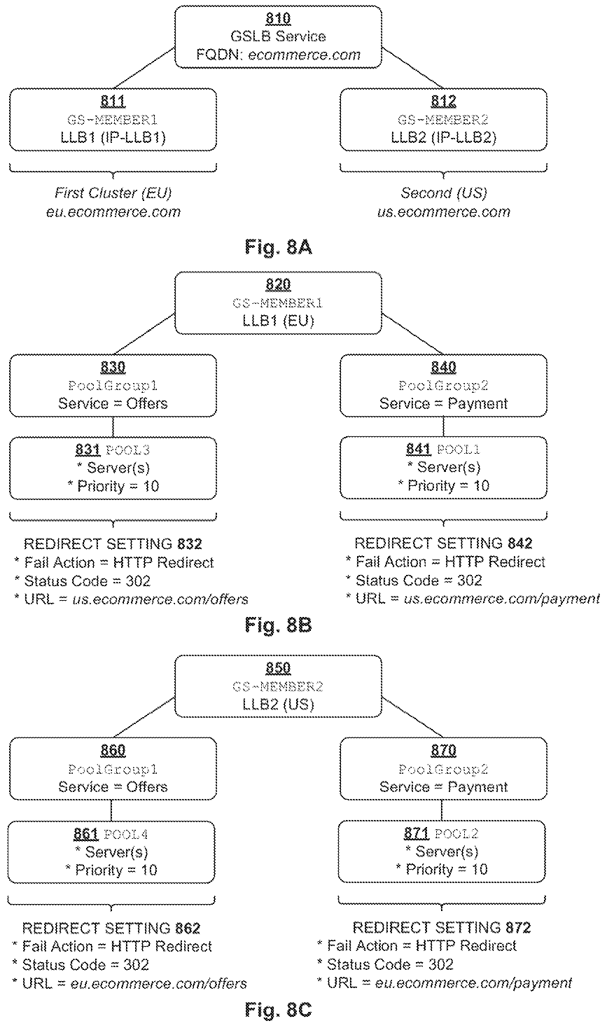

According to a redirect-based approach (see 362 in FIG. 3), LLB1 120 may interact with client device 140 to redirect the request towards to cause LLB2 130 to select a particular second backend server to process the request. In this case, prior to receiving the request, LLB1 120 may perform failure handling configuration by configuring a redirect setting for the first pool. The redirect setting may specify a fail action (e.g., HTTP redirect), status code (e.g., 302) and uniform resource locator (URL) specifying a path associated with the second pool. Based on the redirect setting, LLB1 120 is aware of a path (e.g., “/payment” in URL=“https://us.ecommerce.com/payment”) associated with the second pool in second cluster 102. This “path-aware” approach provides a proactive approach for failure handling in multi-cluster environment 100. Compared to the proxy-based approach, the redirect-based approach may cause more resource usage at the client's end. Various examples will be discussed using FIGS. 7-8.

Examples of the present disclosure may be implemented together with any suitable GSLB solution(s), including but not limited to VMware NSX® Advanced Load Balancer™ (ALB) that is available from VMware, Inc.; AVI Kubernetes Operator (AKO) and AVI multi-cluster Kubernetes Operator (AMKO) from AVI Networks™ (trademark of VMware, Inc.), etc. In general, AKO may refer to a pod running in Kubernetes clusters that provides communication with a Kubernetes master to provide configuration. AKO may remain in synchronization with required Kubernetes objects and calls application programming interfaces (APIs) provided by an AVI controller to deploy ingress services via AVI service engines. The AMKO may be implemented to facilitate multi-cluster deployment to extend application ingress controllers across multiple regions. AMKO may call APIs for AVI controller to create GSLB services on a leader cluster that synchronizes with follower clusters.

### FIRST EXAMPLE

### Proxy-Based Approach

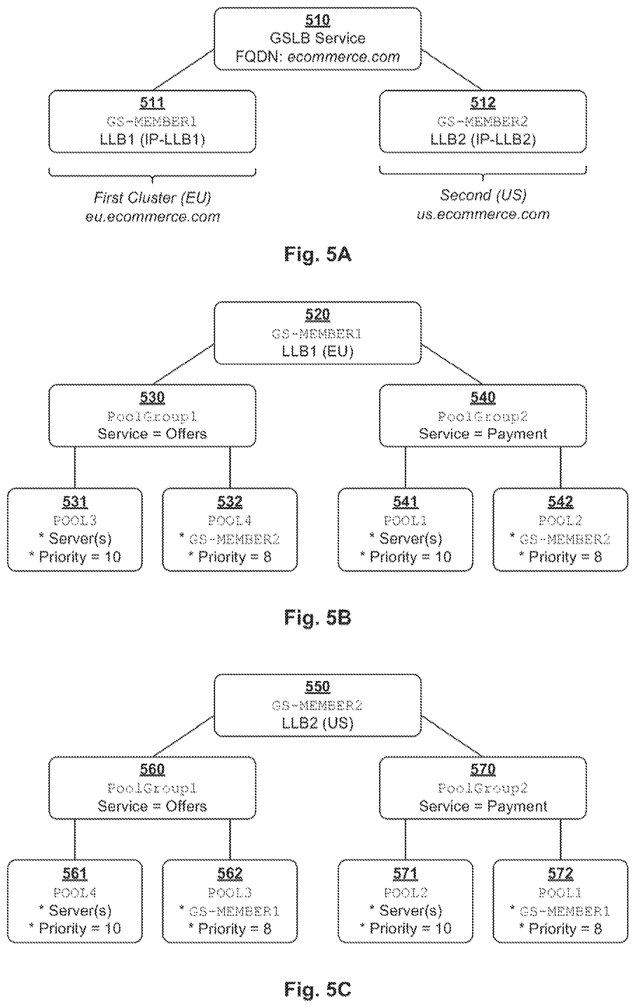

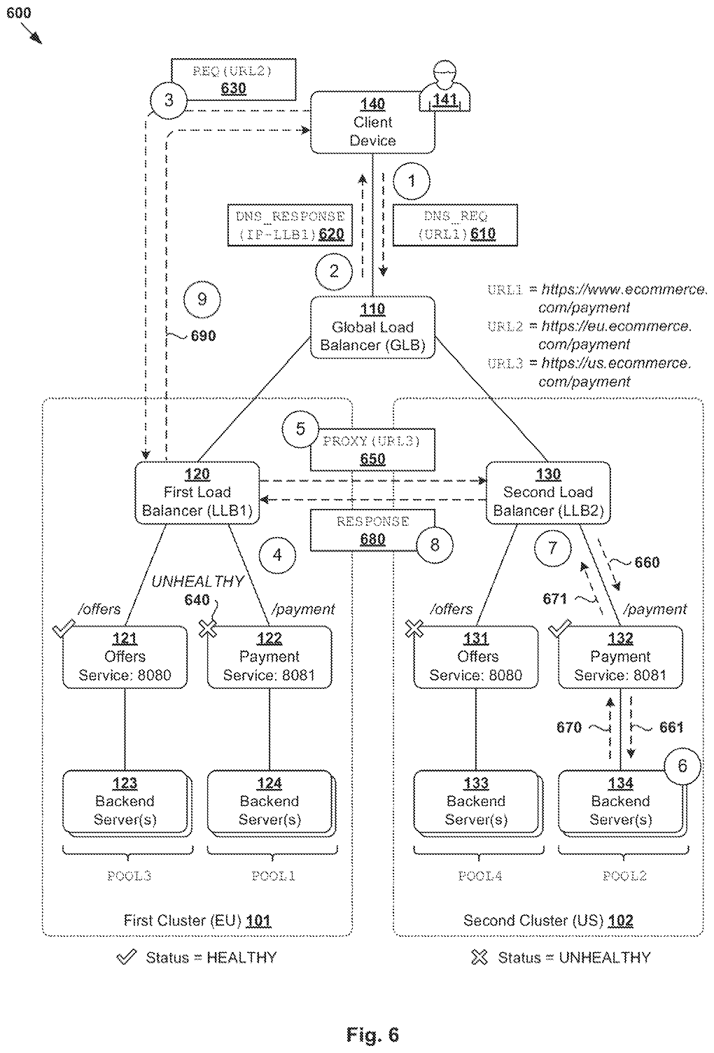

FIG. 4 is a flowchart of example detailed process 400 for first load balancer 120 to perform service-aware GSLB according to a proxy-based approach. Example process 400 may include one or more operations, functions, or actions illustrated by one or more blocks, such as 410 to 495. Depending on the desired implementation, various blocks may be combined into fewer blocks, divided into additional blocks, and/or eliminated. The example in FIG. 4 will be described using FIGS. 5A-C and FIG. 6.

Throughout the present disclosure, “local” and “remote” are relative terms. The term “local” may refer to a scenario where an entity or construct (e.g., pool group, pool, backend server, etc.) resides in or is associated with the same cluster or geographical site compared to a load balancer. The term “remote” may refer to another scenario where the entity or construct resides in a different cluster or geographical site compared to the load balancer. Although local “POOL1” and remote “POOL2” are shown in FIG. 4 for simplicity, the example is applicable to any suitable local and remote pools. Also, LLB2 130 in second cluster 102 may perform blocks 410-425 and 455-485 to proxy or redirect request(s) towards LLB1 120 in first cluster 101.

(a) GSLB Service Configuration

At 410 in FIG. 4, GSLB service configuration may be performed for a global application that is deployed in multiple clusters 101-102. Here, the term “GSLB service” may refer generally to a representation of a global application that front ends instantiations of the application. The term “global application” may refer generally to an application that is deployed in multiple geographically-dispersed clusters (also known as GSLB sites). Depending on the desired implementation, the GSLB service may provide a number of functions, such as (1) defining, synchronizing, and maintaining GSLB configuration; (2) monitoring the health of configuration components; (3) optimizing application service for clients by providing GSLB DNS responses to FQDN requests; (4) processing global application requests; or any combination thereof.

Depending on the desired implementation, a new GSLB service may be configured by a network administrator using a user interface supported by any suitable GSLB solution, such as NSX ALB, AMKO and AKO mentioned above. Further, any suitable interface may be used for the configuration, such as graphical user interface (GUI), command line interface (CLI), API(s), etc. Configuration information may be pushed towards particular load balancer 120/130 via a controller (e.g., AVI controller; not shown) deployed in each cluster 101/102.

FIG. 5A is a schematic diagram illustrating an example GSLB service configuration according to a proxy-based approach. In this example, a GSLB service (see 510) may be configured for a global application that is associated with FQDN=“www.ecommerce.com” by which end-user clients may reference the global application. The GSLB service may be configured to include members in different clusters. At 511, first member=LLB1 120 (“GS-MEMBER1”) is associated with “eu.ecommerce.com” in first cluster 101. At 512, second member=LLB2 130 (“GS-MEMBER2”) is associated with “us.ecommerce.com” in second cluster 102. Each LLB 120/130 may be configured with a virtual IP address, such as IP-LLB1 for LLB1 120, and IP-LLB2 for LLB2 130.

(b) Failure Handling Configuration

At 415-420 in FIG. 4, LLB1 120 and LLB2 130 may be configured to perform proxy-based failure handling during load balancing. According to the proxy-based approach, a client's request may be proxied from one load balancer towards another load balancer. This may involve configuring both LLB1 120 and LLB2 130 to have visibility of individual virtual services, and their health status information, in respective clusters 101-102. In this case, blocks 415-420 may involve (a) configuring a GSLB pool group that includes multiple pools implementing a virtual service and (b) assigning the multiple pools with varying priority levels.

FIG. 5B is a schematic diagram illustrating an example failure handling configuration for a first load balancer (i.e., LLB1 120) according to a proxy-based approach. In this example, block 415 may involve configuring two pool groups (see 530, 540) for LLB1 120 in first cluster 101 (see 520) in the EU region. At 530, first pool group 530 is configured to include two GSLB pools 531-532 implementing service=offers 121/131. A local pool (see “POOL3” 531) includes local backend server(s) 123 in first cluster 101, and a remote pool (see “POOL4” 532) includes remote backend server(s) 133 in second cluster 102. At 540, second pool group 540 includes two GSLB pools 541-542 implementing service=payment 122/132. A local pool (see “POOL1” 541) includes backend server(s) 124 in first cluster 101, and a remote pool (see “POOL2” 542) includes backend server(s) 134 in second cluster 102.

For each service, local and remote GSLB pools are assigned with different priority levels. In this case, block 415 may involve assigning local pool 531/541 is assigned with a first priority level (e.g., 10) that is higher than a second priority level (e.g., 8) assigned to remote pool 532/542. This way, local pool 531/541 is configured to take precedence or priority to handle traffic when its status=HEALTHY. However, when there is a failure that causes a state transition from HEALTHY to UNHEALTHY, traffic may be steered (i.e., proxied) from local pool 531/541 in first cluster 101 towards remote pool 532/542 in second cluster 102.

FIG. 5C is a schematic diagram illustrating an example failure handling configuration for a second load balancer (i.e., LLB2 130) according to a proxy-based approach. Similarly, block 420 may involve configuring pool groups (see 560, 570) for LLB2 130 in second cluster 102 (see 550) in the US region. First pool group 560 is configured to include two GSLB pools 561-562 implementing service=offers 121/131. A local pool (see “POOL4” 561) includes local backend server(s) 133 in second cluster 102, and a remote pool (see “POOL3” 562) includes remote backend server(s) 123 in first cluster 101. Second pool group 570 includes two GSLB pools 571-572 implementing service=payment 122/132. A local pool (see “POOL2” 571) includes local backend server(s) 134 in second cluster 102, and a second pool (see “POOL1” 572) includes remote backend server(s) 124 in first cluster 101.

For each service, local and remote GSLB pools are assigned with different priority levels. In this case, block 420 may involve assigning local pool 561/571 with a first priority level (e.g., 10) that is higher than a second priority level assigned to remote pool 562/572 (e.g., 8). This way, local pool 561/571 takes precedence or priority to handle traffic when its status=HEALTHY. However, when there is a failure that causes a state transition to UNHEALTHY, traffic may be steered (i.e., proxied) from local pool 561/571 in second cluster 102 towards remote pool 562/572 in first cluster 101.

(c) Health Monitoring

At 425-430 in FIG. 4, GSLB service health monitoring may be performed to monitor the health of services and associated backend server(s) in each cluster 101/102. In practice, health monitoring may be performed using health monitor(s) configured on the control plane and/or data plane. In this case, LLB 120/130 may obtain information specifying the health status of services in each cluster 101/102 from the health monitor(s). The term “obtain” may refer generally to LLB 120/130 receiving or retrieving the health status information. The health monitor(s) may be implemented by LLB 120/130, or a separate monitoring entity.

The health status may be updated according to any suitable factor(s), including availability (e.g., UP or DOWN), performance metric information (e.g., latency satisfying a desired threshold), etc. Any suitable approach may be used by health monitors to assess the health status, such as ping, TCP, UDP, DNS, HTTP(S), etc. Using control-plane-based health monitoring, LLB 120/130 (or a controller) may perform periodic health checks to determine the health status of local services in their local cluster 101/102. LLB1 120 and LLB2 130 may also query each other to determine the health status of remote services in respective clusters 101-102.

Additionally or alternatively, data-plane-based health monitoring may be implemented. Unlike the control-plane approach, health checks go directly to participating services (i.e., the data plane). The cycling loop of health monitors may be avoided in such a way that health monitors are consumed and not forwarded to remote site(s). One way to achieve this is by adding headers to health monitors and data script to consume health monitoring requests.

(d) Failure Handling

Example proxy-based failure handling will now be explained using blocks 435-495 in FIG. 4 and FIG. 6, which is a schematic diagram illustrating example service-aware GSLB according 600 to a proxy-based approach. The example in FIG. 6 may be implemented based on the configuration at blocks 410-430 in FIG. 4.

At 610 in FIG. 6, client device 140 operated by end user 141 may access the payment service by generating and sending a DNS request for URL1=“https://www.ecommerce.com/payment” (i.e., domain name=“ecommerce.com” and path=“/payment”). In response, at 620, GLB 110 may perform load balancing to select one of N=2 load balancers 120, 130 to handle service requests from client device 140. Any suitable load balancing algorithm may be used by GLB 110, such as proximity based on location information of client device 140, load level at LLB 120/130, round robin, etc. For example, in response to selecting LLB1 120 over LLB2 130, GLB 110 may generate and send a DNS response towards client device 140. The DNS response may resolve the requested domain name into IP address=IP-LLB1 associated with LLB1 120, thereby directing subsequent client's requests for a service towards LLB1 120. See corresponding 435-445 in FIG. 4.

At 630 in FIG. 6, LLB1 120 in first cluster 101 may receive a request from client device 140 to access service=payment 122. The request may be a HTTP(S) request to access URL2=“https://eu.ecommerce.com/payment” specifying path=“payment.” In response, LLB1 120 may identify local POOL1 of first backend server(s) 124 implementing the service and determine its health status. If POOL1 is associated with status=HEALTHY, LLB1 120 may steer the request towards local POOL1 for processing (not shown in FIG. 6). See corresponding 450-470 in FIG. 4

Otherwise, at 640 in FIG. 6, in response to determination that local POOL1 is associated with status=UNHEALTHY, LLB1 120 may perform failure handling according to the configuration at block 415. In particular, LLB1 120 may identify remote POOL2 of second backend server(s) 134 implementing requested service=payment 132 in second cluster 102. Based on the configuration in FIG. 5B, remote POOL2 in second cluster 102 is assigned with priority level=8, which is lower than the priority level=10 assigned to local POOL1 in first cluster 101.

At 650 in FIG. 6, in response to determination that POOL2 is associated with status=HEALTHY, LLB1 120 may interact with LLB2 130 by proxying the request towards LLB2 130. In one example, LLB1 120 may forward the request from client device 140 to LLB2 130, which then parses the request and forwards it to POOL2 of backend server(s) 134. This has the effect of LLB1 120 proxying the request towards URL3=“https://us.ecommerce.com/payment” specifying path=“payment” to access the service implemented by POOL2 in second cluster 102. Using examples of the present disclosure, LLB1 120 has awareness of the health status of the payment service implemented by POOL2, and a path associated with POOL2 in second cluster 102 (i.e., service- and path-aware). See 480-485 in FIG. 4.

At 660 in FIG. 6, LLB2 130 may allow client device 140 operated by end user 141 to access service=payment by selecting particular backend server 134 in POOL2 to process the request. At 670, 680 and 690 in FIG. 6, a response from that particular backend server 134 is then forwarded towards LLB1 120, which in turn forwards it towards client device 140. The proxying process may be repeated for subsequent service requests from client device 140. See 490-495 in FIG. 4.

One advantage of the proxy-based approach is that its implementation is transparent to client device 140 and user 141. Since clusters 101-102 are deployed across geographically-dispersed sites, there might be increased latency and overhead to traffic forwarding between LLB1 120 and LLB2 130. Conventionally, LLB1 120 in first cluster 101 generally does not have access to public IP address or path (e.g., “us.ecommerce.com/payment”) to access a service implemented in second cluster 102. To implement the proxy-based approach, an infrastructure administrator may open IP ports to facilitate cross-cluster communication.

### SECOND EXAMPLE

### Redirect-Based Approach

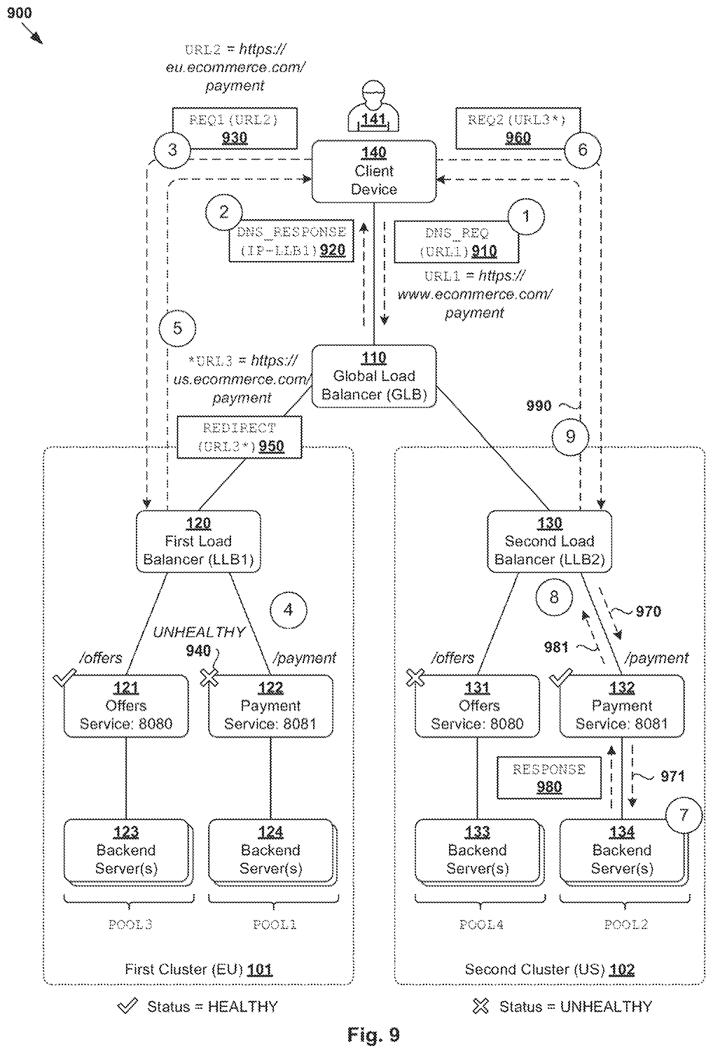

FIG. 7 is a flowchart of example detailed process 700 for first load balancer 120 to perform service-aware GSLB according to a redirect-based approach. Example process 700 may include one or more operations, functions, or actions illustrated by one or more blocks, such as 710 to 790. Depending on the desired implementation, various blocks may be combined into fewer blocks, divided into additional blocks, and/or eliminated. Although local “POOL1” and remote “POOL2” are shown in FIG. 7, it should be understood that the example is applicable to any suitable local and remote pools (i.e., not limited to the payment service). Also, LLB2 130 in second cluster 102 may perform blocks 710-725 and 755-785 to proxy or redirect request(s) towards LLB1 120 in first cluster 101 in a similar manner. The example in FIG. 7 will be described using FIGS. 8A-C and FIG. 9.

(a) GSLB Configuration

At 710 in FIG. 7, GSLB service configuration may be performed for a global application that is deployed in multiple clusters 101-102. FIG. 8A is a schematic diagram illustrating an example GSLB service configuration according to a redirect-based approach. Similar to FIG. 5A, a GSLB service (see 810) may be configured for a global application with FQDN=“www.ecommerce.com.” At 811, first member=LLB1 120 (“GS-MEMBER1”) is associated with “eu.ecommerce.com” in first cluster 101. At 812, second member=LLB2 130 (“GS-MEMBER2”) is associated with “us.ecommerce.com” in second cluster 102. Each LLB 120/130 may be configured with a virtual IP address, such as IP-LLB1 for LLB1 120, and IP-LLB2 for LLB2 130.

(b) Failure Handling Configuration

At 715-720 in FIG. 7, failure handling configuration may be performed for LLB1 120 and LLB2 130. According to the redirect-based approach, LLB1 120 in first cluster 101 may be configured to perform failure handling by redirecting a client's request towards LLB2 130 in second cluster 102, and vice versa. Similarly, this involves configuring both LLB1 120 and LLB2 130 to have visibility of individual virtual services, and their health status information, in respective clusters 101-102. Further, instead of configuring varying priority levels according to the proxy-based approach, a redirect setting may be configured for each local pool, such as using a user interface, datascript, etc.

In more detail, FIG. 8B is a schematic diagram illustrating an example failure handling configuration for first load balancer 120 according to a redirect-based approach. In this example, block 715 may involve configuring a first pool group (see 830) and a second pool group (see 840) for LLB1 120 in first cluster 101 (see 820) in the EU region. For service=offers, first pool group 830 is configured to include a local pool (see “POOL3” 831) of backend server(s) 123 in first cluster 101. For service=payment, second pool group 840 includes a local pool (see “POOL1” 841) of backend server(s) 124 in first cluster 101.

Block 715 in FIG. 7 may further involve configuring a redirect setting for each local pool in first cluster 101. For example in FIG. 8B, a redirect setting for service=offers may specify a fail action (e.g., HTTP redirect), a status code (e.g., 302 redirect message) and a URL to access that service via LLB2 130 in second cluster 102 (e.g., URL=“https://us.ecommerce.com/offers” with path=“/offers”). Similarly, a redirect setting for service=payment may specify a fail action (e.g., HTTP redirect), a status code (e.g., 302 redirect message) and a URL to access the service via LLB2 130 (e.g., URL=“https://us.ecommerce.com/payments” with path=“/payment”). See 832 and 842 in FIG. 8B.

FIG. 8C is a schematic diagram illustrating an example failure handling configuration for second load balancer 130 according to a redirect-based approach. Here, block 720 may involve configuring a first pool group (see 860) and a second pool group (see 870) for LLB2 130 in second cluster 102 (see 850) in the US region. For service=offers, first pool group 860 is configured to include a local pool (see “POOL4” 861) of backend server(s) 133 located in second cluster 102. For service=payment, second pool group 870 includes a local pool (see “POOL2” 871) of backend server(s) 134 in second cluster 102.

Block 720 in FIG. 7 may further involve configuring a redirect setting associated with each local pool in second cluster 102. In the example in FIG. 8C, a redirect setting for service=offers may specify a fail action (e.g., HTTP redirect), a status code (e.g., 302) and a URL to access the service via LLB1 120 in first cluster 101 in the EU region (e.g., URL=“https://eu.ecommerce.com/offers” with path name=“/offers”). A redirect setting for service=payment may specify a fail action (e.g., HTTP redirect), a status code (e.g., 302) and a URL to access the service via LLB1 120 (e.g., URL=“https://eu.ecommerce.com/payments” with path name=“/payment”). See 852 and 862 in FIG. 8C. Conventionally, note that LLB 120/130 is generally not aware of the URL and path associated with a service in a remote cluster.

(c) Health Monitoring

At 725-730 in FIG. 7, GSLB service health monitoring may be performed to monitor the health of services and associated backend server(s) in each cluster 101/102. Similar to the examples in FIG. 4, health monitoring may be performed using health monitor(s) configured on the control plane and/or data plane. In this case, LLB 120/130 may obtain information specifying the health status of services in each cluster 101/102 from the health monitor(s). Details discussed using blocks 425-430 in FIG. 4 are applicable here, and not repeated for brevity.

(d) Redirect-Based Failure Handling

Example proxy-based failure handling will now be explained using blocks 750-793 in FIG. 7 and FIG. 9. In particular, FIG. 9 is a schematic diagram illustrating example 700 of service-aware GSLB according to a redirect-based approach. The example in FIG. 9 may be implemented based on the GSLB and failure handling configuration at blocks 710-720 in FIG. 7.

At 910 in FIG. 9, client device 140 may access the payment service by generating and sending a DNS request for URL1=“www.ecommerce.com/payment.” In response, GLB 110 may perform load balancing to select one of N=2 load balancers 120, 130 to handle service requests from client device 140. Any suitable load balancing algorithm may be used, such as proximity based on location information of client device 140, load level at LLB 120/130, round robin, etc.

At 920 in FIG. 9, in response to selecting LLB1 120 over LLB2 130, GLB 110 may generate and send a DNS response towards client device 140. The DNS response may resolve the requested domain name into IP address=IP-LLB1 associated with LLB1 120. This has the effect of directing subsequent requests for service from client device 140 towards LLB1 120 in first cluster 101. See also 735-745 in FIG. 7.

At 930 in FIG. 9, LLB1 120 in first cluster 101 may receive a request from client device 140 to access service=payment 122. The request may be a HTTP(S) request to access URL2=“https://eu.ecommerce.com/payment” specifying path=“payment.” In response, LLB1 120 may identify local POOL1 of backend server(s) 124 implementing the service and determine its health status based on health monitoring at block 725 in FIG. 7. In response to determination that POOL1 is associated with status=HEALTHY, LLB1 120 may steer the request towards local POOL1 for processing (not shown in FIG. 9). See also 750-770 in FIG. 7

Otherwise, at 940 in FIG. 9, in response to determination that local POOL1 is associated with status=UNHEALTHY, LLB1 120 may perform failure handling according to the configuration at block 715. Based on redirect setting 842 in FIG. 8B, LLB1 120 may identify remote POOL2 of backend server(s) 134 implementing requested service=payment 132 in second cluster 102.

At 950 in FIG. 9, in response to determination that POOL2 is associated with status=HEALTHY, LLB1 120 may interact with client device 140 by generating and sending a redirect message towards client device 140. Based on redirect setting 842 in FIG. 8B, the redirect message may be a HTTP redirect message with status code=302 and URL3=“us.ecommerce.com/payment” for redirection towards LLB2 130 in second cluster 102. Using examples of the present disclosure, LLB1 120 may perform failure handling based on awareness of the health status of the payment service implemented by POOL2, and a path associated with POOL2 in second cluster 102 (i.e., service- and path-aware). See corresponding 780-790 in FIG. 7.

At 960 in FIG. 9, LLB2 130 in second cluster 102 may receive a subsequent request from client device 140 to access service=payment 132. The request may be a HTTP(S) request to access URL3=“https://us.ecommerce.com/payment” specifying path=“payment” associated with POOL2. In response, LLB2 130 may identify local POOL2 of backend server(s) 134 implementing the payment service and determine its health status. Since local POOL2 is associated with status=HEALTHY, LLB2 130 may steer the request towards particular backend server 134 that is selected from local POOL2 for processing. At 970, 980-981 and 990 in FIG. 9, a response from that particular backend server 134 is then forwarded towards client device 140. See corresponding 791-793 in FIG. 7.

Although the examples in FIGS. 4-9 are described using POOL1 and POOL2 implementing service=payment, it should be understood that service-aware GSLB may be performed for other pool groups and pool group members, including POOL3 and POOL4 implementing service=offers. Further, multi-cluster environment 100 may include more than two clusters. In this case, LLB1 120 may perform failure handling by proxying or redirecting requests to a particular load balancer one of remote clusters in the examples in FIG. 6 and FIG. 9.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 9. For example, a computer system capable of supporting load balancer 110/120/130 may be deployed in multi-cluster environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

What is claimed is:

1. A method for a first load balancer to perform service-aware global server load balancing, wherein the method comprises:
receiving, from a client device, a request to access a service associated with an application that is deployed in at least a first cluster and a second cluster, wherein the request is directed towards the first load balancer based on load balancing by a global load balancer;
identifying a first pool implementing the service in the first cluster, wherein the first pool includes one or more first backend servers selectable by the first load balancer to process the request; and
in response to determination that the first pool in the first cluster is associated with an unhealthy status,
identifying a second pool implementing the service in the second cluster, wherein the second pool is associated with a healthy status and includes one or more second backend servers selectable by a second load balancer to process the request; and
performing failure handling by interacting with the client device, or the second load balancer, to allow the client device to access the service implemented by the second pool in the second cluster.

2. The method of claim 1, wherein performing failure handling comprises:
based on configuration performed prior to receiving the request, proxying or redirecting the request towards the second load balancer to cause the second load balancer to select a particular second backend server to process the request.

3. The method of claim 2, wherein the method further comprises:
performing the configuration according to a proxy-based approach by (a) configuring a pool group that includes the first pool and the second pool implementing the service and (b) assigning the second pool with a second priority level that is lower than a first priority level assigned to the first pool.

4. The method of claim 3, wherein performing failure handling comprises:
based on the configuration, interacting with the second load balancer to proxy the request towards the second load balancer to allow the client device to access the service implemented by the second pool assigned with the second priority level.

5. The method of claim 2, wherein the method further comprises:
performing the configuration according to a redirect-based approach by configuring a redirect setting for the first pool, wherein the redirect setting includes a uniform resource locator (URL) specifying a path associated with the second pool.

6. The method of claim 5, wherein performing failure handling comprises:
interacting with the client device by generating and sending a redirect message to the client device, wherein the redirect message is configured to cause the client device to send a subsequent request to access the service implemented by the second pool using the URL.

7. The method of claim 1, wherein the method further comprises:
identifying the unhealthy status associated with the first pool and the healthy status associated with the second pool based on information obtained from one or more health monitors.

8. A non-transitory computer-readable storage medium that includes a set of instructions which, in response to execution by a processor of a computer system, cause the processor to perform service-aware global server load balancing, wherein the method comprises:
receiving, from a client device, a request to access a service associated with an application that is deployed in at least a first cluster and a second cluster, wherein the request is directed towards the first load balancer based on load balancing by a global load balancer;
identifying a first pool implementing the service in the first cluster, wherein the first pool includes one or more first backend servers selectable by the first load balancer to process the request; and
in response to determination that the first pool in the first cluster is associated with an unhealthy status,
identifying a second pool implementing the service in the second cluster, wherein the second pool is associated with a healthy status and includes one or more second backend servers selectable by a second load balancer to process the request; and
performing failure handling by interacting with the client device, or the second load balancer, to allow the client device to access the service implemented by the second pool in the second cluster.

9. The non-transitory computer-readable storage medium of claim 8, wherein performing failure handling comprises:
based on configuration performed prior to receiving the request, proxying or redirecting the request towards the second load balancer to cause the second load balancer to select a particular second backend server to process the request.

10. The non-transitory computer-readable storage medium of claim 9, wherein the method further comprises:
performing the configuration according to a proxy-based approach by (a) configuring a pool group that includes the first pool and the second pool implementing the service and (b) assigning the second pool with a second priority level that is lower than a first priority level assigned to the first pool.

11. The non-transitory computer-readable storage medium of claim 10, wherein performing failure handling comprises:
based on the configuration, interacting with the second load balancer to proxy the request towards the second load balancer to allow the client device to access the service implemented by the second pool assigned with the second priority level.

12. The non-transitory computer-readable storage medium of claim 9, wherein the method further comprises:
performing the configuration according to a redirect-based approach by configuring a redirect setting for the first pool, wherein the redirect setting includes a uniform resource locator (URL) specifying a path associated with the second pool.

13. The non-transitory computer-readable storage medium of claim 12, wherein performing failure handling comprises:
interacting with the client device by generating and sending a redirect message to the client device, wherein the redirect message is configured to cause the client device to send a subsequent request to access the service implemented by the second pool using the URL.

14. The non-transitory computer-readable storage medium of claim 8, wherein the method further comprises:
identifying the unhealthy status associated with the first pool and the healthy status associated with the second pool based on information obtained from one or more health monitors.

15. A computer system, comprising a first load balancer to perform the following:
receive, from a client device, a request to access a service associated with an application that is deployed in at least a first cluster and a second cluster, wherein the request is directed towards the first load balancer based on load balancing by a global load balancer;
identify a first pool implementing the service in the first cluster, wherein the first pool includes one or more first backend servers selectable by the first load balancer to process the request; and
in response to determination that the first pool in the first cluster is associated with an unhealthy status,
identify a second pool implementing the service in the second cluster, wherein the second pool is associated with a healthy status and includes one or more second backend servers selectable by a second load balancer to process the request; and
perform failure handling by interacting with the client device, or the second load balancer, to allow the client device to access the service implemented by the second pool in the second cluster.

16. The computer system of claim 15, wherein the first load balancer is to perform failure handling by performing the following:
based on configuration performed prior to receiving the request, proxy or redirect the request towards the second load balancer to cause the second load balancer to select a particular second backend server to process the request.

17. The computer system of claim 16, wherein the first load balancer is further to perform the following:
perform the configuration according to a proxy-based approach by (a) configuring a pool group that includes the first pool and the second pool implementing the service and (b) assigning the second pool with a second priority level that is lower than a first priority level assigned to the first pool.

18. The computer system of claim 17, wherein the first load balancer is to perform failure handling by performing the following:
based on the configuration, interact with the second load balancer to proxy the request towards the second load balancer to allow the client device to access the service implemented by the second pool assigned with the second priority level.

19. The computer system of claim 16, wherein the first load balancer is further to perform the following:
perform the configuration according to a redirect-based approach by configuring a redirect setting for the first pool, wherein the redirect setting includes a uniform resource locator (URL) specifying a path associated with the second pool.

20. The computer system of claim 19, wherein the first load balancer is to perform failure handling by performing the following:
interact with the client device by generating and sending a redirect message to the client device, wherein the redirect message is configured to cause the client device to send a subsequent request to access the service implemented by the second pool using the URL.

21. The computer system of claim 15, wherein the first load balancer is further to perform the following:
identify the unhealthy status associated with the first pool and the healthy status associated with the second pool based on information obtained from one or more health monitors.
